(19) United States
(12) Patent Application Publication
(10) Pub. No.: US 2006/0172173 A1
(43) Pub. Date: Aug. 3, 2006

(54) Storage medium and electronic apparatus, and information read-out apparatus

(75) Inventor: Atsushi Misawa, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/342,670

(22) Filed: Jan. 31, 2006

(30) Foreign Application Priority Data
Jan. 31, 2005 (JP) 2005-024127

(51) Int. Cl. H01M 8/04; B65D 6/00

(52) U.S. Cl. 429/34; 220/4.12

(57) ABSTRACT

The conventional mobile electronic apparatuses in which a fuel retained in a pack or a fuel cartridge is supplied through a pump to a fuel cell had a defect that, due to the pump incorporated in the apparatus main body, the size and the weight thereof are large, thereby reducing the portability thereof. Moreover, mobile electronic apparatuses in which a liquid fuel is supplied through a dropping pipet to a fuel cell had a defect that a long time is required to the supply work. The present invention provides a storage medium that is detachably mounted in an electronic apparatus equipped with a fuel cell, the storage medium comprising a cartridge in which a fuel for the fuel cell is stored, in order to solve the problem described above.

### BACKGROUND OF THE INVENTION

1. Field of the Invention

The present invention relates to a storage medium and an electronic apparatus, and an information read-out apparatus, and particularly to a storage medium that stores electronic information such as image information, an electronic apparatus equipped with a fuel cell such as a direct methanol fuel cell that utilizes a methanol solution (fuel), and an information read-out apparatus that reads out image information and carries out printing processing.

2. Description of the Related Art

Mobile electronic apparatuses such as a digital camera and a mobile phone with a camera are known that are equipped with a fuel cell and driven with electric power obtained from the fuel cell (e.g., Japanese Patent Application Laid-Open No. 2004-355871).

As a fuel cell equipped in such a mobile electronic apparatus, a direct methanol fuel cell is known in which, by supplying the fuel pole (anode) thereof with a methanol solution as a fuel and supplying the air pole (cathode) thereof with oxygen, electric power is obtained through an electrolyte film such as a proton conductive film.

Moreover, a configuration is also proposed in which a digital camera equipped with a fuel cell is provided with a fuel pack and a sub-pack, and fuels retained in the packs are supplied to the fuel cell through driving power of a pump provided in the digital camera (e.g., Japanese Patent Application Laid-Open No. 2004-139742). Still moreover, a mobile apparatus is also proposed in which a liquid-transport pump is incorporated, and a fuel in a fuel cartridge is supplied to a fuel cell, through driving power of the liquid-transport pump (e.g., Japanese Patent Application Laid-Open No. 2004-119027). Furthermore, a mobile apparatus is also proposed in which a liquid fuel is supplied to a fuel cell, by use of a liquid fuel refueling device, like a dropping pipet (e.g., Japanese Patent Application Laid-Open No. 2001-93551).

### SUMMARY OF THE INVENTION

However, the foregoing conventional mobile electronic apparatuses in which a fuel retained in a pack or a fuel cartridge is supplied through a pump to a fuel cell had a defect that, due to the pump incorporated in the apparatus main body, the size and the weight thereof are large, thereby reducing the portability thereof. Moreover, mobile electronic apparatuses in which a liquid fuel is supplied through a dropping pipet to a fuel cell had a defect that a long time is required to the supply work.

The present invention has been implemented in consideration of the foregoing circumstances; it is an object of the present invention to provide a storage medium that is of a small size and a simple configuration and can supply an electronic apparatus with a fuel, without taking a long labor hour, an electronic apparatus in which the storage medium is mounted, and an information read-out apparatus that can refuel the cell to the storage medium.

In order to achieve the foregoing object, a first aspect of the present invention is characterized in that, in a storage medium that is detachably mounted in an electronic apparatus equipped with a fuel cell, a cartridge is incorporated in which a fuel for the fuel cell is stored.

In a storage medium according to the first aspect, because the storage medium having a storage section incorporates a cartridge in which a fuel is stored, the fuel can be supplied to a fuel cell for an electronic apparatus, simply through the operation of loading the storage medium into the electronic apparatus. Moreover, the user can save the trouble of purchasing the fuel in addition to the storage medium. Still moreover, the fuel in the storage medium can be utilized as a backup battery for the electronic apparatus. In this case, because the storage medium as a backup battery is loaded into the electronic apparatus, the trouble of carrying a backup battery separately can be eliminated.

Furthermore, by utilizing the storage medium according to the present invention, storage medium providing services can be practiced in which the storage medium, which stores the fuel to the extent of being enough to store image information corresponding to the writing capacity of the storage section, is distributed at the users' cost. According to the foregoing services, in a case that the electronic apparatus is a digital camera, it goes without saying that, by merely loading the purchased storage medium into the digital camera, the user can, as ever before, pick up images and store image information in the storage medium; further, by, in the case of exhaustion of the secondary battery for the digital camera, supplying the fuel cell with the fuel in the storage medium and charging the secondary battery with the obtained electric power, the user can continue to pick up images, while prolonging the lifetime of the secondary battery by the time corresponding to the capacity of the fuel.

In addition, in practicing the services, by providing a refueling device in a information read-out apparatus, i.e., a minilab system, installed in a laboratory or at a photo shop, that, based on the user's request, reads out and prints image information that has been stored in the storage medium by user's request of development, the storage medium can be refueled by the cell, for example, when image information is read out. Therefore, because the refueled storage medium is returned to the user, the returned storage medium can be repeatedly utilized as a storage medium having a charging function.

A second aspect of the present invention is characterized in that, in the first aspect, the storage medium is formed in a flat shape, and a fuel port communicated with the cartridge is formed in a flat surface or a side surface, of the storage medium.

In the storage medium according to the second aspect, the fuel port is formed in a flat surface or a side surface of the storage medium, and the fuel is supplied through a fuel supply tube connected to the fuel cell, from the fuel port to the fuel cell.

A third aspect of the present invention is characterized in that, in the second aspect, the fuel port is sealed with a check valve or a membrane.

In the case where the fuel port is sealed with the check valve, the storage medium is required to possess a mechanism for opening and closing the check valve, whereby the structure of the storage medium is rendered slightly complex; however, the storage medium according to the third aspect can make it possible that the simple operation, i.e., opening the check valve by pressing the check valve against the fuel supply tube enables the fuel to be supplied to the fuel cell. Moreover, in the case where, the fuel port is sealed with the membrane, work is rendered necessary in which the membrane that has been broken during supply of the fuel is resealed during refueling; however, the membrane is not required to have the opening/closing mechanism, whereby an advantage is demonstrated in that the structure of the storage medium is simplified.

A fourth aspect of the present invention is characterized in that, in an electronic apparatus in which the storage medium according to any one of the first, second, or third aspect, is detachably mounted, a fuel supply section is provided that supplies the fuel stored in the cartridge of the storage medium to the equipped fuel cell.

In the electronic apparatus according to the fourth aspect, the fuel supply section is provided that supplies the fuel cell with the fuel stored in the fuel cartridge of the storage medium; therefore, by merely loading into the electronic apparatus the storage medium in which the cartridge is integrally provided, the fuel stored in the fuel cartridge can be supplied to the fuel cell.

A fifth aspect of the present invention is characterized in that, in the fourth aspect, the electronic apparatus is a camera in which image information obtained by picking up an image of a photographic subject is stored in the storage section of the storage medium.

The electronic apparatus according to the fifth aspect is a so-called digital camera, and images picked up by the digital camera are stored as image information in the storage section of the storage medium. The electronic apparatus is not limited to a digital camera, and can be exemplified by a typical silver-salt camera, a mobile phone with a camera, or a versatile mobile electronic communication apparatus such as a PDA (Personal Digital Assistant).

A sixth aspect of the present invention is characterized in that, in an information read-out apparatus in which the storage medium according to any one of the first, the second, or the third aspect, is mounted and a read-out device for reading out information stored in a storage section of the storage medium is incorporated, a refueling device for refueling the cartridge in the storage medium is incorporated.

With an information read-out apparatus according to the sixth aspect, because, when information stored in a storage section of a storage medium is read out, a refueling device refuels a cartridge of the storage medium, reading of the information as well as refueling can be carried out.

A seventh aspect of the present invention is characterized in that, in the sixth aspect, the information read-out apparatus is a printer including a printing section for printing an image based on image information read out from the storage section of the storage medium.

With the information read-out apparatus according to the seventh aspect, when the storage medium is loaded into the printer as an information read-out apparatus, image information stored in the storage section of the storage medium is read out by a read-out section of the printer, and an image based on the image information is printed by a printing section. The printer can be exemplified such as a self-serve shopfront digital-print system (manufactured by Fuji Photo Film Co., Ltd.: “Princiao Q”) that can immediately create high-image-quality color prints of images picked up by a digital camera. The foregoing digital-print system features operation through touch-panel monitor, high-image-quality print finishing, and diverse print menus, utilized as a shopfront reception machine through digital photo booth, and installed at places where people gather, such as a camera-specialty store, a mass-sales store, a station yard, a sightseeing resort, a hotel, and a supermarket.

As described above, in a storage medium according to the present invention, because the storage medium having a storage section incorporates a cartridge in which a fuel is stored, the fuel can be supplied to a fuel cell for an electronic apparatus, simply through the operation of loading the storage medium into the electronic apparatus. Moreover, the user is exempted from the trouble of purchasing a fuel separately from a storage medium, and can utilize the fuel as a secondary battery for the electronic apparatus.

Still moreover, in an electronic apparatus according to the present invention, a fuel supply section is provided that supplies a fuel cell with a fuel stored in the fuel cartridge of a storage medium; therefore, by merely loading into the electronic apparatus the storage medium in which the cartridge is integrally provided, the fuel stored in the fuel cartridge can be supplied to the fuel cell.

Furthermore, in an information read-out apparatus according to the present invention, because, when information stored in a storage section of a storage medium is read out, a refueling device refuels a cartridge of the storage medium, reading of the information as well as refueling can be carried out.

### BRIEF DESCRIPTION OF THE DRAWINGS

FIG. 1 is an overall perspective view illustrating a memory pack and a camera according to an embodiment;

FIG. 2 is a perspective view of the camera illustrated in FIG. 1, when viewed from the rear side;

FIG. 3 is an enlarged perspective view of the memory pack illustrated in FIG. 1;

FIG. 4 is a block diagram illustrating the configuration of the camera illustrated in FIG. 1;

FIG. 5 is a block diagram illustrating a printer according to an embodiment;

FIG. 6 is a flowchart illustrating a mode of usage for the printer in FIG. 5;

FIG. 7 is a perspective view illustrating the front surface of a memory pack as another embodiment of a storage medium;

FIG. 8 is a perspective view of the rear surface of the memory pack illustrated in FIG. 7;

FIG. 9 is a cross-sectional view, of the memory pack, taken along the line 9-9 in FIG. 7;

FIG. 10 is an explanatory view illustrating the configuration of the fuel supply section of the memory pack illustrated in FIG. 7;

FIG. 11 is an explanatory view illustrating the configuration of the fuel supply section of the memory pack illustrated in FIG. 7;

FIG. 12 is a perspective view illustrating the front surface of a memory pack as another embodiment of a storage medium;

FIG. 13 is an explanatory view illustrating the configuration of the fuel supply section of the memory pack illustrated in FIG. 12; and

FIG. 14 is an explanatory view illustrating the configuration of the fuel supply section of the memory pack illustrated in FIG. 12.

### DETAILED DESCRIPTION OF THE PREFERRED EMBODIMENTS

Preferred embodiments of a storage medium and an electronic apparatus, and an information read-out apparatus according to the present invention will be explained in detail below, with reference to the accompanying drawings.

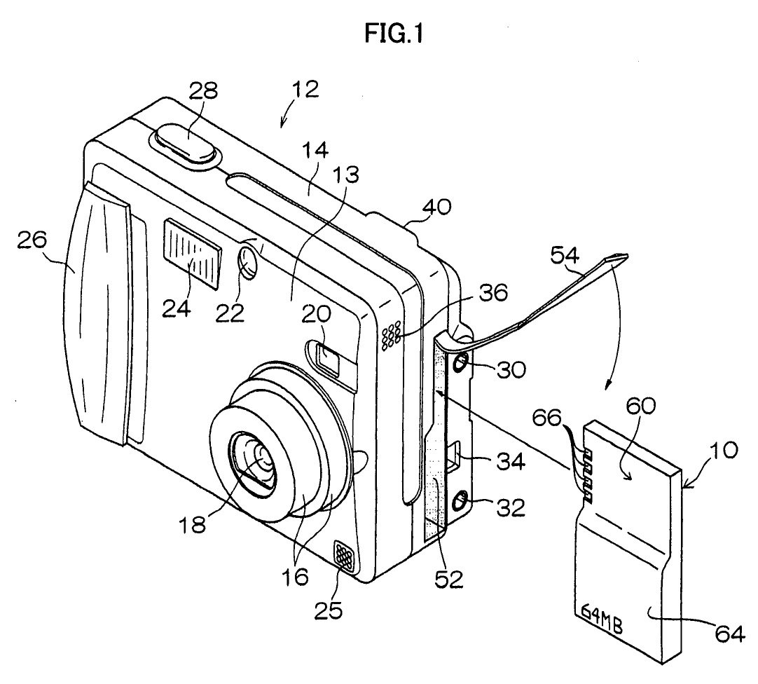

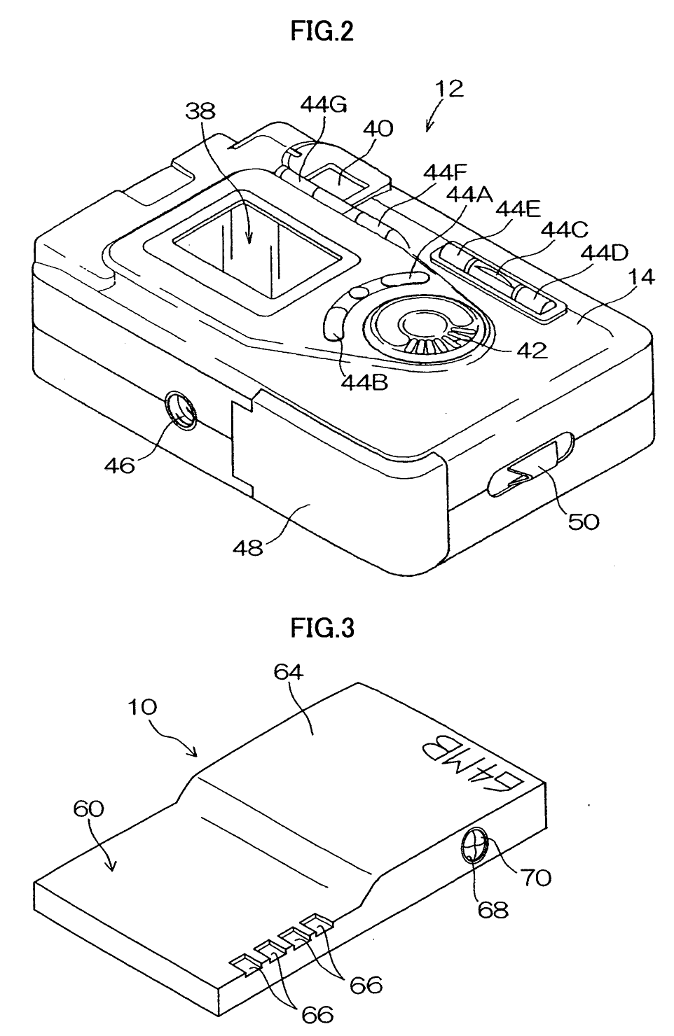

FIG. 1 is an overall perspective view of a camera (electronic apparatus) 12 that is loaded with a memory pack (storage medium) 10 according to the present invention; and FIG. 2 is a rear perspective view of the camera 12.

The camera 12 illustrated in FIGS. 1 and 2 is a digital camera having a record/playback function for still images and moving images and a voice record/playback function. The exterior cover of the camera 12 is formed of a front cover 13 and a rear cover 14. On the front cover 13, an image pickup lens 18 disposed in a collapsible camera cone 16, a viewfinder 20, a stroboscopic-light control sensor 22, a strobe 24, a sound collector 25 for a microphone, and a power switch 26 that plays the role of a grip are provided at respective predetermined positions. The power switch 26 is horizontally slidably provided on the front cover 13; by sliding the power switch 26, electric power is turned ON or OFF. Moreover, a lens cover (unillustrated) for protecting the image pickup lens 18 at the collapse position is provided on the front cover 13; when the image pickup lens 18 is protruded, the lens cover is driven so as to open, in response to the protrusion of the image pickup lens 18.

A shutter button 28 is provided on the top side of the exterior cover of the camera 12. When the shutter button 28 is pressed halfway, an automatic-focusing function is activated, whereupon focusing of the image pickup lens 18 is implemented. Then, full press of the shutter button 28 makes an image to be picked up. On the one side of the exterior cover of the camera 12, a video terminal 30 to which a video cable is connected, a power input terminal 32 to which a power adaptor is connected, a connecter 34 to which a USB cable or a cradle is connected, and a sound output section 36 for a speaker are provided at respective predetermined positions. Moreover, on the one side of the exterior cover, a loading room 52 for the memory pack 10 is formed; through the loading room 52, the memory pack 10 is loaded into the camera 12. The loading room 52 is obstructed in an openable and closable manner, by use of a sheet-like cap 54 formed of an elastic member such as rubber.

As illustrated in FIG. 2, on the rear cover 14 of the camera 12, a LCD monitor 38, a viewfinder 40, a dial 42, and multiple operation buttons 44A, 44B to 44G are provided at respective predetermined positions. In the case where the camera 12 is in an image-pickup mode, an image picked up through the image pickup lens 18 of FIG. 1 is displayed on the LCD monitor 38 that is utilized as an electronic viewfinder. In contrast, in the case where the camera 12 is in the playback mode, an image that has been picked up and recorded is displayed. In addition, the LCD monitor 38 is also utilized to display image-pickup modes.

The dial 42 in FIG. 2 is pivotably provided on the rear cover 14 by pivotally operating the dial 42, the operation mode is switched to the playback mode, an image-pickup mode, the moving image mode, or the like. To the operation button 44A, a function for implementing menu calling or each operation is assigned; to the operation button 44B, a function for stopping each operation is assigned. To the operation button 44C, a function for implementing zooming operation is assigned; to the operation button 44D, a function for selecting a strobe setting; and the operation button 44E, a function for selecting the short-distance image pickup mode. The operation buttons 44C to 44E are utilized when, in the case where the menu screen is displayed on the LCD monitor 38, the cursor is shifted, or when, in the playback mode, images are advanced frame by frame. The operation button 44F is utilized to set the number of pixels or the sensitivity; the operation button 44G is utilized to divide the display screen.

In the bottom side of the exterior cover of the camera 12, a hole 46 for mounting a tripod and a battery cover 48 are provided. The battery cover 48 is mounted openable and closable on the exterior cover, and attached and detached, through pivotal operation and horizontally sliding operation. By opening the battery cover 48, a secondary battery can be attached to and detached from the camera 12. In addition, Reference Numeral 50 in FIG. 2 designates a strap mounting lug.

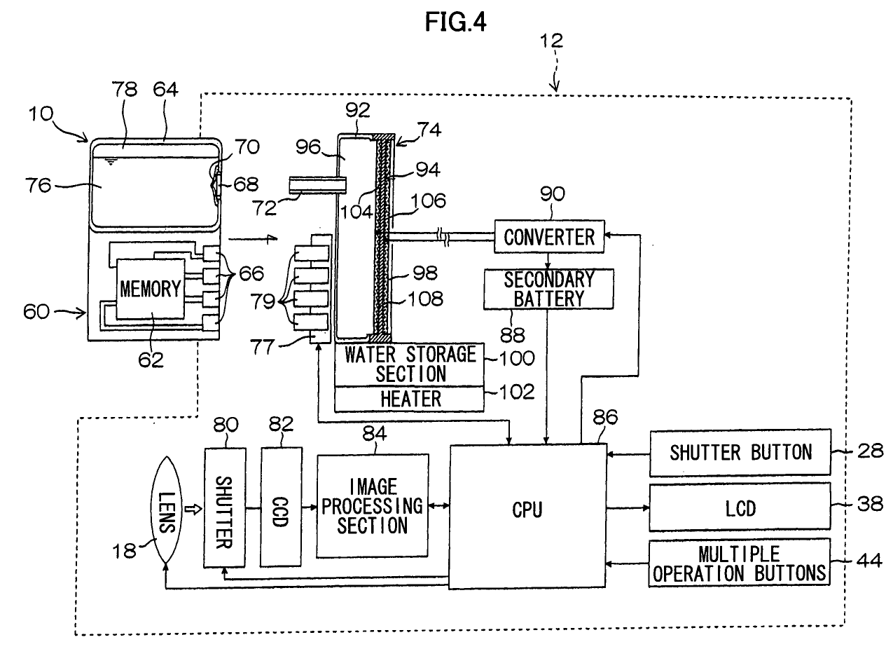

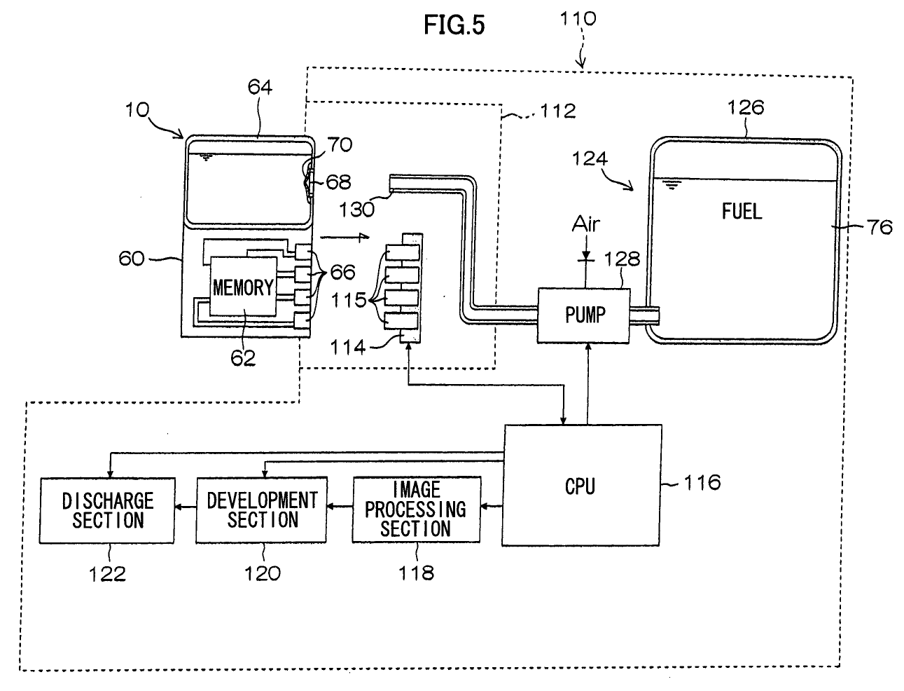

As illustrated in FIGS. 3 and 4, the memory pack 10 is a storage medium configured in such a way that a plastic case 60 as a pack main body incorporates a memory section (storage section: e.g., a RAM) 62 and a fuel cartridge 64. On the outer surface of the case 60, terminals 66, 66, . . . for connecting the memory section 62 to external connectors; at a fuel port 68 of the fuel cartridge 64, a check valve 70 for obstructing the fuel port 68, in an openable and closable manner.

The case 60 is formed in an approximately flat shape in which the thickness of the memory section 62 is small, and the thickness of the fuel cartridge 64 is slightly larger than that of the memory section 62; on the surface of the memory section 62 of a small thickness, the terminals 66, 66, . . . are arranged side by side, and in the end section of the fuel cartridge 64 of a larger thickness, the fuel port 68 is formed. Because the fuel port 68 is formed at that position, in conjunction with the operation of loading the memory pack 10 into the camera 12, a tube (fuel supply section) 72 of the camera 12 presses and opens the check valve 70. Accordingly, the fuel cartridge 64 is communicated through the tube 72 with a fuel cell 74 for the camera 12, whereby a fuel 76 in the fuel cartridge 64 is supplied to the fuel cell 74. In addition, compressed air 78 is enclosed, along with the fuel 76, in the fuel cartridge 64; through the pressure of the compressed air 78, the fuel 76 is pressure-fed to the fuel cell 74.

FIG. 4 is a block diagram illustrating the configuration of the camera 12.

FIG. 4 illustrates the condition in which the memory pack 10 has not been loaded into the loading room 52 (refer to FIG. 1) of the camera 12. When the memory pack 10 is loaded into the loading room 52, the terminals 66, 66, . . . of the memory pack 10 are connected to the corresponding terminals 79, of the connector 77, that are exposed in the loading room 52. Concurrently, as described above, the fuel cartridge 64 is communicated through the tube 72 with the fuel cell 74 for the camera 12.

As can be seen from FIG. 4, when the shutter button 28 is pressed, a shutter 80 in the image pickup system opens, photographic-subject light that enters through the image pickup lens 18 forms an image on the image forming plane of the CCD 82, and the optical data is converted into electrical image data. The image data is image-processed by an image processing section 84, and then stored as image data in the memory section 62 of the memory pack 10 loaded in the loading room 52 (refer to FIG. 1).

Each sections incorporated in the camera 12 is integrally controlled by a CPU 86. A secondary battery 88, i.e., a battery, is connected to the CPU 86. Each of sections incorporated in the camera 12 is driven by electric power charged in the secondary battery 88. The secondary battery 88 is incorporated in the camera 12. Moreover, when electric power charged in the secondary battery 88 is insufficient, the CPU 86 activates a converter 90, thereby making the fuel cell 74 generate electric power. Then, electric power is supplied from the fuel cell 74 to the secondary battery 88, so that the secondary battery 88 is charged. When the charging is completed, the CPU 86 stops the operation of the converter 90, thereby making the fuel cell 74 stop generating electric power.

Next, the fuel cell 74 will be explained.

The fuel cell 74 according to the present embodiment is a direct methanol fuel cell; the casing 92 of the fuel cell 74 is segmented through a battery cell 94 into a fuel room 96 and an air room 98. The root end of the tube 72 is connected to the fuel room 96; the front end of the tube 72 is exposed in the loading room 52 (refer to FIG. 1).

On the fuel cell 74, a water storage section 100 is provided adjacent to the air room 98. The water storage section 100 is communicated through an unillustrated drain outlet with the air room 98. Accordingly, water created in the air room 98 is stored through the drain outlet in the water storage section 100. The water stored in the water storage section 100 is heated into steam, through the heat of a heater 102 adjacent to the water storage section 100, and discharged toward the outside of the camera 12, through an unillustrated drain outlet. The heater 102 is driven also when the camera 12 is utilized in a low-temperature environment. In other words, in general, the fuel cell 74 cannot create chemical reaction in an environment of low-temperature such as below-freezing temperature, but, due to being heated by the heater 102, creates chemical reaction, thereby generating electric power. Thus, the single heater 102 plays both roles as a water vaporizing heater and a heater for heating up the fuel cell 74.

The battery cell 94 is configured of a fuel pole 104 that makes up a wall surface of the fuel room 96, an air pole 106 that makes up a wall surface of the air room 98, and a proton conductive film 108 interposed between the fuel pole 104 and the air pole 106.

When the fuel 76 is supplied into the fuel room 96, and a voltage is applied to the fuel pole 104, the fuel is decomposed into carbon dioxides, hydrogen ions and electrons by catalytic reaction in the fuel pole 104. The carbon dioxides are discharged from the fuel room 96 to the outer air, through an unillustrated gas-liquid separation filter provided on a wall surface of the fuel room 96 and an unillustrated exhaust hole provided on the camera 12. The hydrogen ions pass through the proton conductive film 108 to move to the air pole 106. Electrons flow through the converter 90 to the secondary battery 88, whereby the secondary battery 88 is charged.

The hydrogen ions moved to the air pole 106 pass through an unillustrated gas-liquid separation filter provided on a wall surface of the air room 98, and then couple to form water with oxygen and electrons that have flowed through an air inlet (unillustrated) of the camera 12 into the air room 98. The water passes through the drain outlet and is stored in the water storage section 100. Thereafter, the water is heated into steam through the heat of the heater 102, as described above and discharged toward the outer air.

Next, the operation of the memory pack 10 and the camera 12 will be explained.

Unlike a typical memory pack in which only a memory section is incorporated, the memory pack 10 according to the present embodiment includes in addition to the memory section 62 the fuel cartridge 64 in which the fuel 76 for a fuel cell is stored.

Therefore, with the memory pack 10, when, as illustrated in FIG. 4, the memory pack 10 is loaded into the loading room 52 of the camera 12 (refer to FIG. 1), the terminals 66, 66, . . . of the memory pack 10 are connected to the corresponding terminals 79, of the connector 77, that are exposed in the loading room 52. Concurrently, due to the check valve 70 being pressed by the tube 72 to open, the fuel cartridge 64 is communicated through the tube 72 with the fuel cell 74 for the camera 12. Accordingly, the operation of merely loading the memory pack 10 into the loading room 52 enables the fuel 76 in the fuel cartridge 64 to be supplied to the fuel cell 74 of the camera 12. Moreover, because the fuel 76 is stored in the memory pack 10, the user can save the trouble of purchasing the fuel in addition to the memory pack 10. Still moreover, the fuel 76 in the memory pack 10 can be utilized as a backup battery for the camera 12. In this case, because the memory pack 10 as a backup battery is loaded into the camera 12, the trouble of carrying a backup battery separately can be eliminated.

Furthermore, by utilizing the memory pack 10, memory-pack providing services can be practiced in which the memory pack 10, which stores the fuel 76 to the extent of being enough to store image information corresponding to the writing capacity of the memory section 62, is distributed at the user's cost. According to the services, it goes without saying that, by merely loading the purchased memory pack 10 into the camera 12, the user can, as ever before, pick up images and store the image information in the memory section 62 of the memory pack 10. Further, by, in the case of exhaustion of the secondary battery 88 of the camera 12, supplying the fuel cell 74 with the fuel 76 in the memory pack 10 and charging the secondary battery 88 with the obtained electric power, the user can continue to pick up images, while prolonging the lifetime of the secondary battery 88 by the time corresponding to the capacity of the fuel 76.

In addition, in practicing the services, by providing a refueling device in a information read-out apparatus, i.e., a minilab system, installed in a laboratory or at a photo shop, that, based on the user's request, reads out and prints image information that has been stored in the memory pack 10, the memory pack 10 can be refueled with the fuel 76, for example, when image information is read out. The memory pack 10 refueled with the fuel 76 is returned to the user; therefore, the returned memory pack 10 can be repeatedly utilized as the memory pack 10 having a charging function.

Meanwhile, in the camera 12, the tube 72 is provided that supplies the fuel cell 74 with the fuel 76 stored in the fuel cartridge 64 of the memory pack 10. Therefore, by merely loading into the camera 12 the memory pack 10 in which the fuel cartridge 64 is integrally provided, the fuel 76 stored in the fuel cartridge 64 can be supplied to the fuel cell 74.

In addition, in the present embodiment, the camera 12 has been exemplified by a digital camera. However, the camera 12 is not limited to the digital camera, but can be exemplified by a typical silver-salt camera, a mobile phone with a camera, or a versatile mobile electronic communication apparatus such as a PDA (Personal Digital Assistant). It is preferable that the amount of the fuel 76 enclosed in the memory pack 10 is enough to store in the memory section 62 picked up images and use up the memory section 62 in the case where the memory pack 10 is kept loaded while the camera is in the normal played back mode or the like. However, in the case where the capacity of the memory section 62 is large, or in the case where priority is given to the downsizing of the memory pack 10, i.e., in the case where the amount of the fuel 76 is reduced, the amount of the fuel 76 should not necessarily be enough to satisfy the condition described above. In such a case, the memory pack 10 may be utilized in combination with an auxiliary refueling method (e.g., a fuel supply method in which, directly through a dropping pipet or the like, the fuel is made to permeate into the fuel pole).

FIG. 5 is a block diagram illustrating the configuration of a printer 110, i.e., an information read-out apparatus.

In a read-out section of the printer 110, a loading room 112 in which the memory pack 10 is loaded is provided. In the loading room 112, a card reader 114 is arranged that, when the memory pack 10 is loaded, is connected to the terminals 66, 66, . . . of the memory pack 10 and reads out image information stored in the memory section 62 of the memory pack 10. In addition, in the loading room 112, in order to enable another storage medium such as a CDROM or a floppy disk to be accommodated, a CDROM reader, a floppy disk reader, or the like is arranged.

The reader 114 is controlled by a CPU 116. Under the control of the CPU 116, image information read out by the reader 114 is forwarded to an image processing section 118 and further to a development section 120, whereupon a photograph is created. The photograph is discharged toward the outside, through a discharge section 122. The image processing section 118 and the development section 120 corresponds to a printing section according to the present invention. In addition, in place of the development section 120, an ink-jet printer section or a laser printer section may be provided.

Meanwhile, in the printer 110 according to the present embodiment, a refueling section (a refueling device) 124 is provided. The refueling section 124 is configured of a tank 126, a pump 128, and a tube 130; the front end of the tube 130 is arranged exposed in the loading room 112.

When the memory pack 10 is loaded into the loading room 112 of the printer 110, the terminals 66, 66, . . . of the memory pack 10 are connected to the corresponding terminals 115, 115, . . . of the reader 114, that are exposed in the loading room 52. Concurrently, due to the check valve 70 being pressed by the tube 130 to open, the fuel cartridge 64 of the memory pack 10 is communicated through the tube 130 with the tank 126 for the printer 110. In the tank 126, the fuel 76 is stored. The fuel 76 is sucked in, due to the pump 128 being driven. The fuel 76 sucked in through the pump 128 and air that is also sucked in through the pump 128 are supplied through the tube 130 to the fuel cartridge 64 of the memory pack 10 that has been loaded into the loading room 112, whereby the fuel cartridge 64 is refueled with the fuel 76 along with compressed air.

The foregoing refueling operation is carried out by utilizing the time during which images are being read out and/or during which photographic development is being carried out. Thus, with the printer 110 according to the present embodiment, after photographic development is completed, the memory pack 10 containing the fuel 76 fully refueled in the fuel cartridge 64 can be returned to the user. Accordingly, electric power necessary for image pickup is secured with the fuel 76 in the memory pack 10. Therefore, the user does not have to go out of his way to carry a backup secondary battery. It is possible to provide a refueling port besides the fuel port 68.

Next, an example of a method of utilizing the printer 110 will be explained.

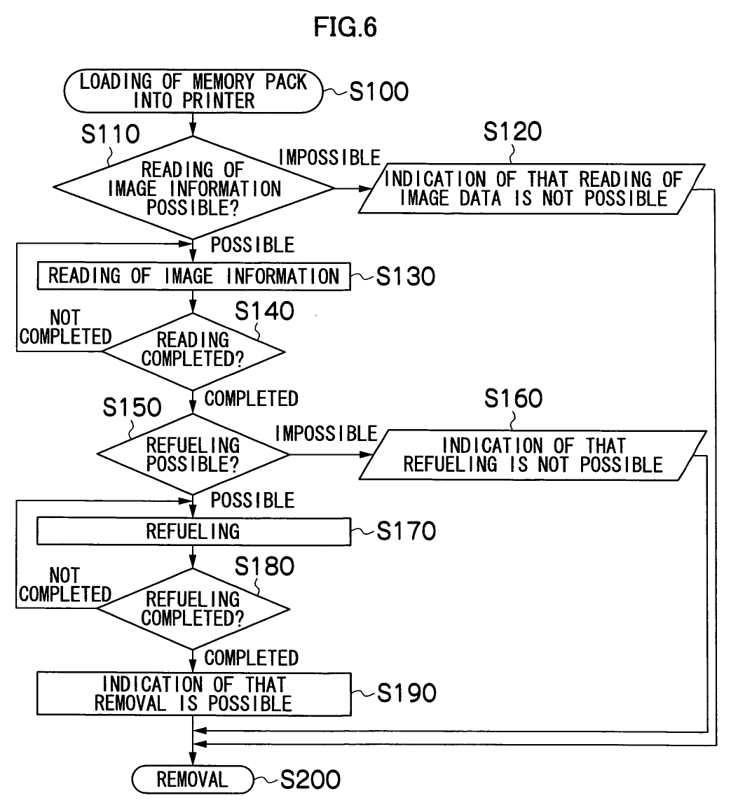

FIG. 6 is a flowchart illustrating procedures for read-out processing and refueling processing that the reader 114 and the refueling section 124 are made to implement by the CPU 116, respectively, when the memory pack 10 is loaded into the loading room 112 of the printer 110.

According to FIG. 6, after, in the step S100, the memory pack 10 is loaded into the loading room 112 of the printer 110, and the terminals 115, 115, . . . of the reader 114 are connected to respective terminals 66, 66, . . . of the memory pack 10, in the first place, in the step S110, the CPU 116 determines whether or not image information in the memory section 62 of the memory pack 10 can be read in. In the determination, if the CPU 116 determines that, due to a memory pack that the printer 110 cannot deal with being loaded into the loading room 112, the image information in the memory section 62 cannot be read in, the CPU proceeds to the step S 120 and makes a warning lamp light so as to indicate that the reading of the memory is not possible, and then ends the processing flow. The warning lamp is a display lamp provided on the display screen of the printer 110 or at a position where the user can easily view the lamp.

In contrast, if the CPU 116 determines in the step S110 that the image information stored in the memory section 62 of the memory pack 10 can be read out by the reader 114, the CPU 116 proceeds to the step S130 where the reading of image information is started. Next, the CPU 116 proceeds to the step S140, and repeats the step S140, while checking whether or not the reader 114 has completed the reading of the image information.

Thereafter, the reading of the image information has been completed in the step S140, the CPU 116 proceeds to the step S150, and determines whether or not refueling is possible. In the step S150, if the CPU 116 determines that, due to a certain defect (such as a damage to the memory pack 10 or a damage to the check valve 70), refueling is impossible, the CPU 116, in the step S160, makes the warning lamp light so as to indicate that refueling is impossible and then ends the processing flow. Therefore, it is preferable that, in the printer 110, a sensor for detecting a defect in the memory pack 10 is provided.

Next, in the step S150, if the CPU 116 determines that refueling is possible, the CPU 116 proceeds to the step S170, and, by driving the pump 128, starts refueling the fuel cartridge 64 of the memory pack 10. Thereafter, in the step S180, the CPU 116 determines whether or not the refueling has been completed. When determining that the refueling has been completed, the CPU 116 makes the warning lamp light, in the step S190, so as to indicate that the memory pack 10 can be removed from the loading room 112.

As described above, the reading of image information in the memory pack 10 and the refueling of the fuel cartridge 64 are carried out sequentially. Then, in the step S200, by removing the memory pack 10 from the loading room 112, the refueled memory pack 10 is returned to the user. In addition, in the printer 110, by making it possible to automatically charge refueling expenses at the same time when an order for printing is placed, user's trouble of paying money can be saved, whereby convenience can further be enhanced.

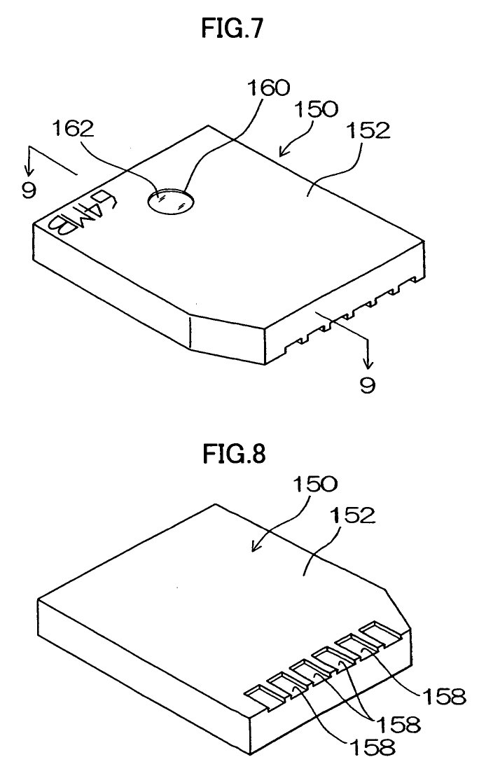

FIGS. 7 and 8 are perspective views illustrating a memory pack 150 as another embodiment of a storage medium. FIGS. 7 and 8 illustrate the front and the rear surface, of the memory pack 150, respectively.

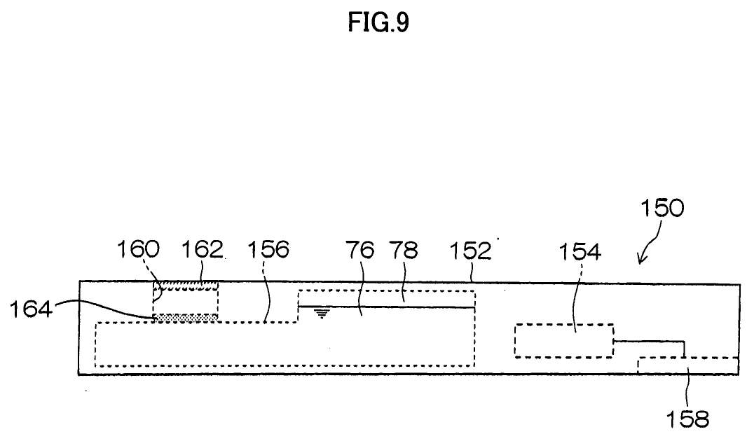

The memory pack 150 is configured of a memory section 154 and a fuel cartridge 156 that are contained, as illustrated in FIG. 9, in a flat-shape case 152 formed in an approximately rectangular form. As illustrated in FIG. 8, terminals 158, 158, . . . of the memory section 154 are arranged on the rear surface of the memory pack 150. In addition, the fuel 76 and the compressed air 78 are enclosed in the fuel cartridge 156 in FIG. 9. a fuel port 160 of the fuel cartridge 156 is formed in the front surface of the memory pack 150, as illustrated in FIG. 7. The fuel port 160 is sealed with a metal thin film (membrane) 162 as well as a rubber film 164 attached inside the fuel port 160. In addition, in order to prevent the thin film 162 from being easily broken by a nail or the like, the thin film 162 is provided in a tensioned state at a position slightly lower than the surface of the fuel port 160.

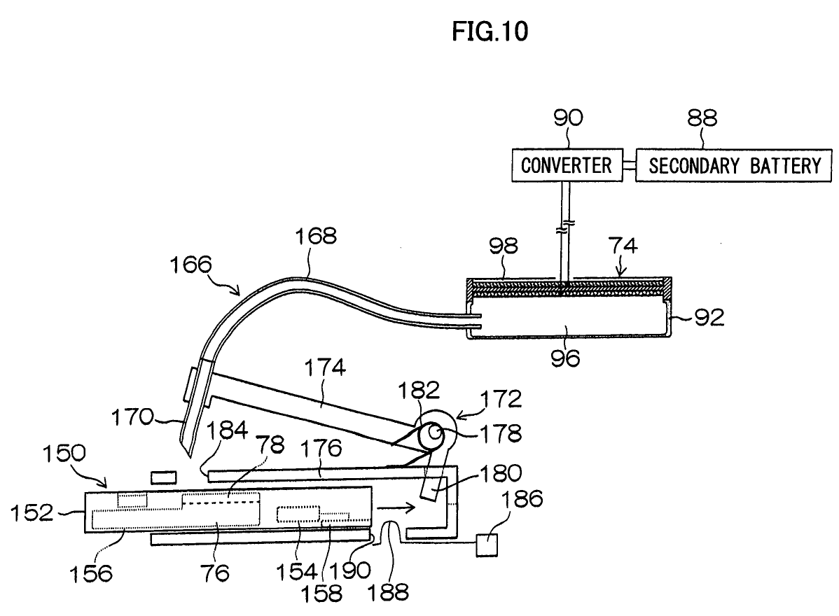

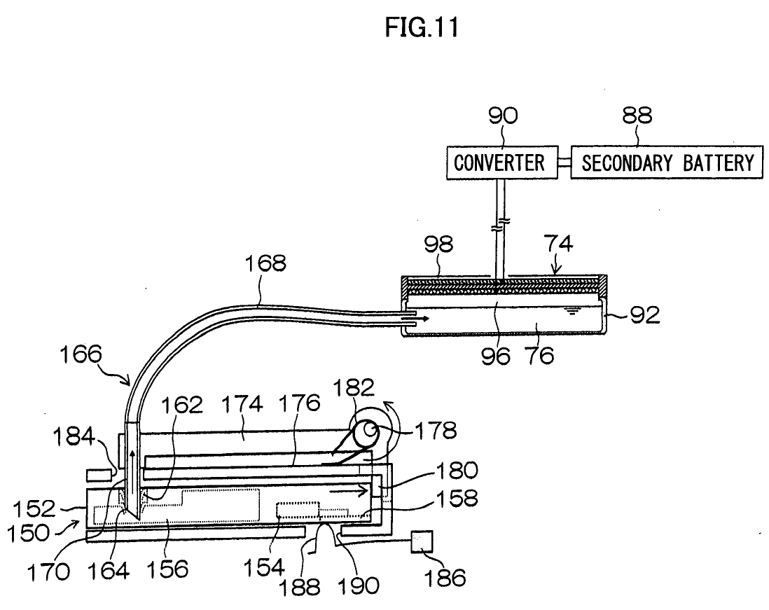

FIGS. 10 and 11 illustrate the configurations of the fuel cell 74 and a fuel supply section 166 that are provided in an electronic apparatus. The configuration of the fuel cell 74 in FIGS. 10 and 11 is the same as that of the fuel cell 74 illustrated in FIG. 4. Therefore, the explanation will be omitted.

As illustrated in FIG. 10, the fuel port 166 is configured of a flexible tube 168 connected to the fuel room 96 of the fuel cell 74, a nozzle 170, having a front edge formed in a spike-like form, that is connected to the front end of the tube 168, and a moving section 172 for moving the nozzle 170.

The moving section 172 has an arm 174 that holds the nozzle 170 at the front end thereof; the root end of the arm 174 is pivotably supported on an axle 178 arranged adjacent to a loading case 176 for the memory pack 150. A protruding fin 180 is formed in the root end of the arm 174. The protruding fin 180 is arranged thrusting into the loading case 176 interior through an unillustrated slot defined by cutting the loading case 176. Moreover, the arm 174 is urged in the clockwise direction, in FIG. 10, with respect to the axle 178, through urging force of a coil spring 182 arranged between the arm 174 and the loading case 176. Still moreover, as illustrated in FIG. 11, an opening 184 for allowing the nozzle 170 to enter the loading case 176 and an opening 190 for allowing a leaf-spring-like terminal 188 provided on a connector 186 of the electronic apparatus to enter the loading case 176 are formed in the loading case 176.

With the fuel supply section 166 configured as described above, when, as illustrated in FIG. 10, the memory pack 150 is loaded into the loading case 176, the front end, in the direction of the insertion, of the memory pack 150 abuts on the protrusive chip 180 of the arm 174; through the continuing loading operation, the protrusive chip 180 is pressed by the memory pack 150. Accordingly, the arm 174 pivots in the counterclockwise, in FIG. 11, against the urging force of the coil spring 182. Then, as illustrated in FIG. 11, after the memory pack 150 is inserted throughout the loading case 176, the nozzle 170 enters, due to the pivot of the arm 174, the loading case 176 through the opening 184, whereupon the front-end spike portion of the nozzle 170 enters the fuel cartridge 156, while breaking the metal thin film 162 and the rubber film 164. Through the foregoing operation, the fuel 76 in the fuel cartridge 156 is pressure-fed by the pressure of the compressed air 78, from the nozzle 170 to the fuel room 96 of the fuel cell 74, through the tube 168, whereby the fuel 76 of the memory pack 150 is supplied to the fuel cell 74.

In this situation, the broken rubber film 164 adheres, due to elastic force thereof, around the nozzle 170. Therefore, the fuel 76 is prevented from leaking out from the fuel cartridge 156. Moreover, because the terminal 188 of the connector 186 elastically makes contact with the terminal 158 of the memory section 154, the memory section 154 and the connector 186 are connected to each other, whereby electronic information obtained in the electronic apparatus is stored in the memory section 154.

In the memory pack 10 illustrated in FIG. 3, the fuel port 68 is sealed with check valve 70. In this case, the memory pack 10 is required to possess a mechanism for opening and closing the check valve 70, whereby the structure of the memory pack 10 is rendered slightly complex. However, the memory pack 10 demonstrates an advantage in that the simple operation, i.e., opening the check valve 70 by pressing the check valve 70 against the tube 72 (refer to FIG. 4) or the tube 130 (refer to FIG. 5) enables the fuel 76 to be supplied to the fuel cell 74. Moreover, in the case where, as the memory pack 150 in FIG. 7, the fuel port 152 is sealed with the thin film 162, work is rendered necessary in which the thin film 162 that has been broken during supply of the fuel is resealed during refueling. However, the thin film 162 is not required to have the opening/closing mechanism, whereby an advantage is demonstrated in that the structure of the memory pack 150 is simplified.

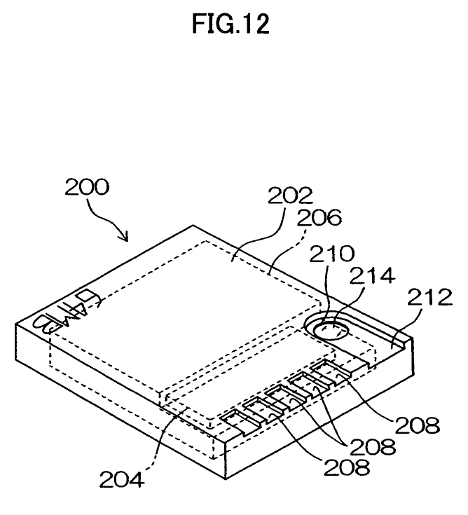

FIG. 12 is a perspective view illustrating a memory pack 200 as another embodiment of a storage medium.

The memory pack 200 is configured of a memory section 204 and a fuel cartridge 206 that are contained in a flat-shape case 202 formed in an approximately rectangular form. In order to obtain maximal capacity for the size of the case 202, the fuel cartridge 206 is formed in a slightly smaller size than that of the case 202. Moreover, the memory section 204 is arranged in the level-difference portion of the fuel cartridge 206; therefore, the space inside the case 202 is efficiently utilized.

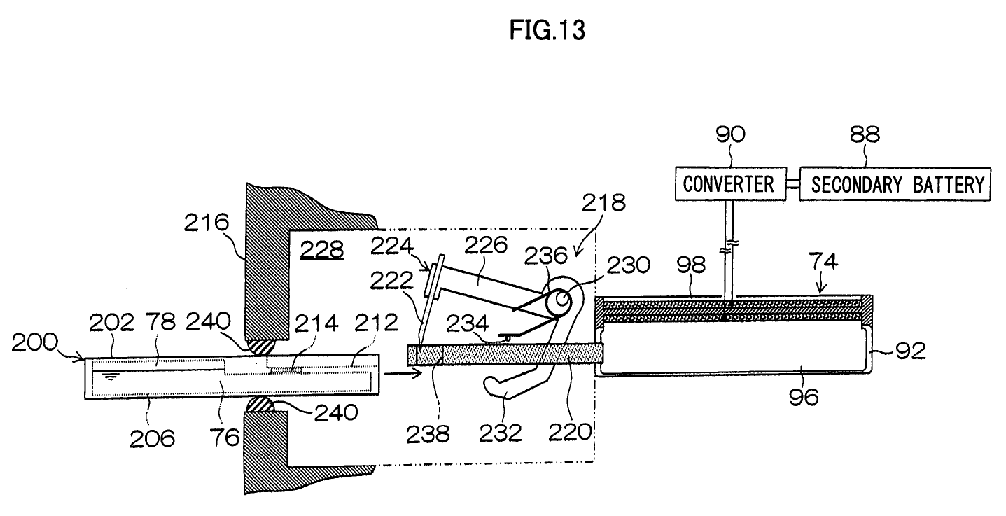

Terminals 208, 208, . . . of the memory section 204 are arranged on the front surface of the memory pack 200. In addition, as illustrated in FIG. 13, the fuel 76 and the compressed air 78 are enclosed in the fuel cartridge 206. As illustrated in FIG. 12, a fuel port 210 of the fuel cartridge 206 is formed in a counterboring portion 212 in the front surface of the memory pack 200. The fuel port 210 is sealed with a metal thin film (membrane) 214.

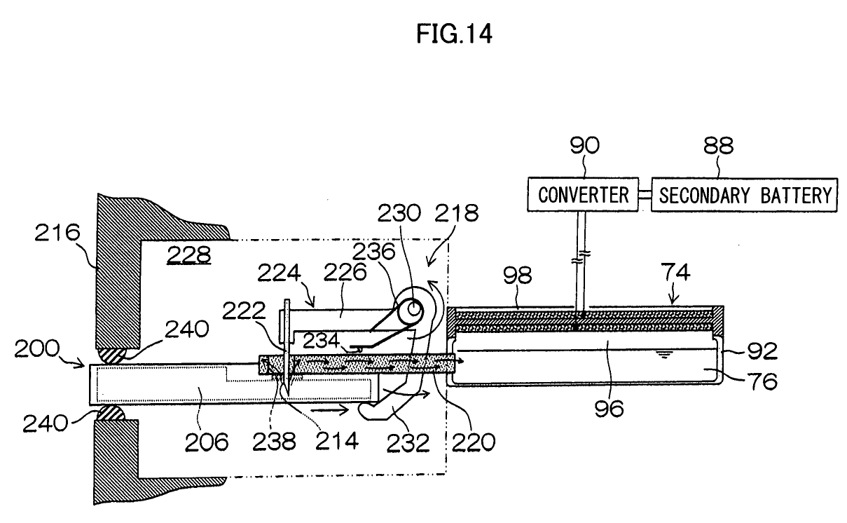

FIGS. 13 and 14 illustrate the configurations of the fuel cell 74 and a fuel supply section 218 that are provided in an electronic apparatus 216. The configuration of the fuel cell 74 in FIGS. 13 and 14 is the same as that of the fuel cell 74 illustrated in FIG. 4; therefore, the explanation will be omitted.

As illustrated in FIG. 13, the fuel port 218 is configured of a permeation unit 220 connected to the fuel room 96 of the fuel cell 74, e.g. sponge, a needle 222 for breaking the thin film 214, and a moving section 224 for moving the needle 222.

The moving section 224 has an arm 226 that holds the needle 222 at the front end thereof. The root end of the arm 226 is pivotably supported on an axle 230 arranged in a loading case 228 for the memory pack 200. A protruding fin 232 is formed in the root end of the arm 226. The protruding fin 232 is arranged thrusting beneath the permeation unit 220 through an unillustrated slot defined by cutting the permeation unit 220. Moreover, the arm 226 is urged in the clockwise direction, in FIG. 13, with respect to the axle 230, through urging force of a coil spring 236 arranged between the arm 226 and a stopper 234 in the loading case 228. Additionally, as illustrated in FIG. 13, an opening 238 for allowing the needle 222 to enter the fuel cartridge 206 is formed in the permeation unit 220.

Meanwhile, at the entrance/exit port of the loading case 228, a rubber packing 240 is mounted that adheres to the front surface, the rear surface and the side surfaces, of the memory pack 200. Because the rubber packing 240 adheres to the memory pack 200, the gasified fuel 76 in the loading case 228 is prevented from leaking outward.

With the fuel supply section 218 configured as described above, when, as illustrated in FIG. 13, the memory pack 200 is loaded into the loading case 228, the front end, in the direction of the insertion, of the memory pack 220 abuts on the protruding fin 232 of the arm 226. Through the continuing loading operation, the protruding fin 232 is pressed by the memory pack 220. Accordingly, the arm 226 pivots in the counterclockwise, in FIG. 13, against the urging force of the coil spring 236. Then, as illustrated in FIG. 14, after the memory pack 220 is inserted throughout the loading case 228, the needle 222 breaks, due to the pivot of the arm 226, the thin film 214 through the opening 238 of the permeation unit 220, whereupon the needle 222 enters the fuel cartridge 206. Due to the foregoing operation, the fuel 76 in the fuel cartridge 206 starts to leak from the fuel port 210 because of the pressure of the compressed air 78, permeates into the permeation unit 220 inserted into the counterboring portion 212, and then is supplied to the fuel room 96 of the fuel cell 74.

In this situation, part of the fuel 76 that has permeated into the permeation unit 220 is gasified in the loading case 228. However, due to the rubber packing 240 adhered to the memory pack 200, the loading case 228 is kept airtight, whereby the gasified fuel 76 never leaks outward. Moreover, in this case, because terminals of an unillustrated connector of the electronic apparatus 216 make contact with the terminals 208, 208, . . . of the memory section 204, the memory section 204 and the connector are connected to each other, whereby electronic information, such as image information, obtained in the electronic apparatus 216 is stored in the memory section 204.

What is claimed is:

1. A storage medium that is detachably mounted in an electronic apparatus equipped with a fuel cell, the storage medium comprising:
a cartridge in which a fuel for the fuel cell is stored.

2. The storage medium according to claim 1,
wherein the storage medium is formed in a flat shape, and a fuel port communicated with the cartridge is formed in a flat surface or a side surface, of the storage medium.

3. An electronic apparatus in which the storage medium according to claim 1 is mounted, comprising:
a fuel supply section for supplying the equipped fuel cell with the fuel stored in the cartridge incorporated in the storage medium.

4. An information read-out apparatus in which the storage medium according to claim 1 is mounted, and a read-out device for reading out information stored in a storage section of the storage medium is incorporated, the information read-out apparatus comprising:
a refueling device for refueling the cartridge incorporated in the storage medium.

5. The storage medium according to claim 2,
wherein the fuel port is sealed with a check valve or a membrane.

6. An electronic apparatus in which the storage medium according to claim 2 is mounted, comprising:
a fuel supply section for supplying the equipped fuel cell with the fuel stored in the cartridge incorporated in the storage medium.

7. An information read-out apparatus in which the storage medium according to claim 2 is mounted, and a read-out device for reading out information stored in a storage section of the storage medium is incorporated, the information read-out apparatus comprising:
a refueling device for refueling the cartridge incorporated in the storage medium.

8. An electronic apparatus in which the storage medium according to claim 3 is mounted, comprising:
a fuel supply section for supplying the equipped fuel cell with the fuel stored in the cartridge incorporated in the storage medium.

9. The electronic apparatus according to claim 3,
wherein the electronic apparatus is a camera in which image information obtained by picking up an image of a photographic subject is stored in a storage section of the storage medium.

10. The electronic apparatus according to claim 6,
wherein the electronic apparatus is a camera in which image information obtained by picking up an image of a photographic subject is stored in a storage section of the storage medium.

11. The electronic apparatus according to claim 8,
wherein the electronic apparatus is a camera in which image information obtained by picking up an image of a photographic subject is stored in a storage section of the storage medium.

12. An information read-out apparatus in which the storage medium according to claim 5 is mounted, and a read-out device for reading out information stored in a storage section of the storage medium is incorporated, the information read-out apparatus comprising:
a refueling device for refueling the cartridge incorporated in the storage medium.

13. The information read-out apparatus according to claim 4,
wherein the information read-out apparatus is a printer including a printing section for printing an image based on image information read out from the storage section of the storage medium.

14. The information read-out apparatus according to claim 7,
wherein the information read-out apparatus is a printer including a printing section for printing an image based on image information read out from the storage section of the storage medium.

15. The information read-out apparatus according to claim 12,
wherein the information read-out apparatus is a printer including a printing section for printing an image based on image information read out from the storage section of the storage medium.
